(19) United States
(12) Patent Application Publication
(10) Pub. No.: US 2025/0015133 A1
(43) Pub. Date: Jan. 9, 2025

(54) Skew Cell Architecture

(71) Applicant: Arm Limited, Cambridge (GB)

(72) Inventors: Sriram Thyagarajan, Austin, TX (US); Yew Keong Chong, Austin, TX (US); Andy Wangkun Chen, Austin, TX (US); Dileep Choorakuzhi Ramakrishnan, Ernakulam (IN); Subramanya Ravindra Shindagikar, Hubli (IN); Ala Srinivasa Rao, Guntur (IN)

(21) Appl. No.: 18/219,292

(22) Filed: Jul. 7, 2023

(51) Int. Cl. H01L 29/06; G06F 30/392; H01L 27/092; H01L 29/78

(52) U.S. Cl. CPC H01L 29/0696; G06F 30/392; H01L 27/0922; H01L 29/7831; G06F 2115/08

(57) ABSTRACT

Various implementations described herein are directed to a device having a skew cell architecture with multiple diffusion regions including P-type diffusion regions disposed between N-type diffusion regions. The device may have power rails including a voltage supply rail disposed between ground rails. The device may have poly-gate rails disposed between the ground rails. The poly-gate rails may be cut to provide an open space between at least one N-type diffusion region and at least one P-type diffusion region.

### BACKGROUND

This section is intended to provide information relevant to understanding the various technologies described herein. As the section's title implies, this is a discussion of related art that should in no way imply that it is prior art. Generally, the related art may or may not be considered prior art. It should therefore be understood that any statement in this section should be read in this light, and not as any admission of prior art.

In some standard cell architectures, some layout designs typically do not allow for L-shaped diffusion regions due to the higher costs of using additional mask layers and due to introduction of leakage effects for some devices. These complications may create challenges in providing skewed sizing for some logic having different sizes for PMOS and NMOS devices. Therefore, due to these fabrication inefficiencies, there exists a need for improved layout designs that allow for skewed cells in many different applications.

### BRIEF DESCRIPTION OF THE DRAWINGS

Implementations of various techniques are described herein with reference to the accompanying drawings. It should be understood, however, that the accompanying drawings illustrate only various implementations described herein and are not meant to limit embodiments of various techniques described herein.

FIGS. 1A-1D illustrate diagrams of double-height skew cell layout architecture in accordance with various implementations described herein.

FIG. 2 illustrates a diagram of multi-input gate architecture in accordance with various implementations described herein.

FIG. 3 illustrates a diagram of double-height skew gate layout architecture in accordance with various implementations described herein.

FIGS. 4A-4B illustrate diagrams of quad-height skew cell layout architecture in accordance with various implementations described herein.

FIG. 5 illustrates a process diagram of a method for providing skew cell layout architecture in accordance with various implementations described herein.

### DETAILED DESCRIPTION

Various implementations described herein relate to skew cell layout schemes and techniques for various circuit related applications in physical designs. Also, in various implementations, the various skew cell layout schemes and techniques described herein provide for a novel skew cell layout architecture that provides for rise and/or fall skewed circuit applications. In various applications, the skew cell layout architecture may provide for high performance multi-height skew-drive cells. For instance, in various applications, the skew cell layout architecture may provide for double-height skew cell NMOS/PMOS layout architecture. In various other applications, the skew cell layout architecture may provide for any height skew cell NMOS/PMOS layout architecture, including, e.g., a quad-height skew cell NMOS/PMOS layout architecture.

In some implementations, the various skew cell layout schemes and techniques described herein may provide for a rise-skewed cell architecture having diffusion regions including P-type diffusion regions disposed between N-type diffusion regions, power rails including a voltage supply rail disposed between ground rails, and poly-gate rails disposed between the ground rails. Also, the poly-gate rails may be cut to provide an open space between at least one N-type diffusion region and at least one P-type diffusion region, so as to thereby provide the rise skew.

In some implementations, the various skew cell layout schemes and techniques described herein may provide for a fall-skewed cell architecture having diffusion regions including N-type diffusion regions disposed between P-type diffusion regions, power rails including a ground rail disposed between voltage supply rails, and poly-gate rails disposed between the voltage supply rails. Also, the poly-gate rails may be cut to provide an open space between at least one P-type diffusion region and at least one N-type diffusion region, so as to thereby provide the fall skew.

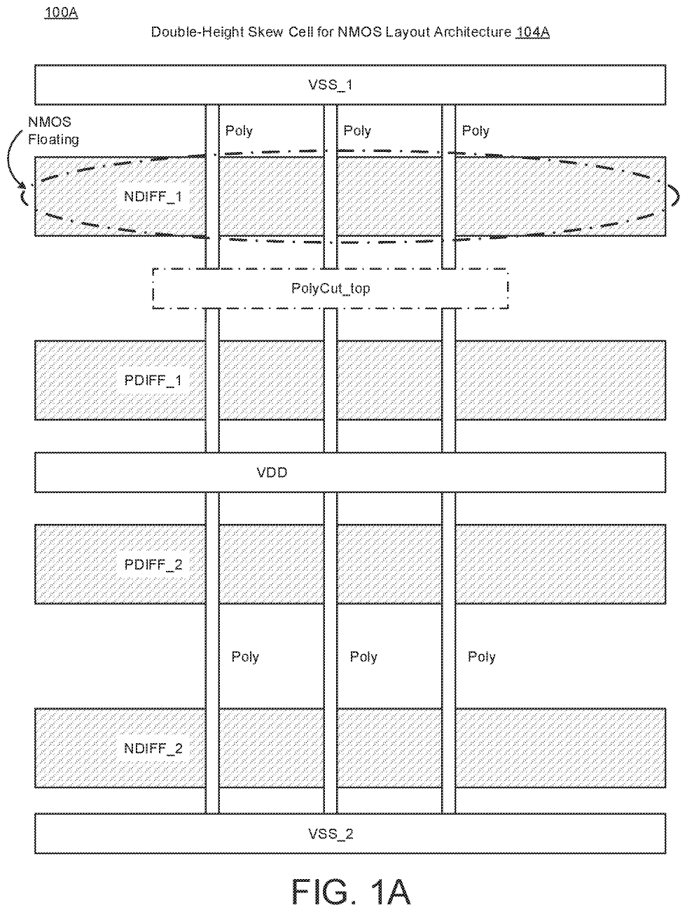

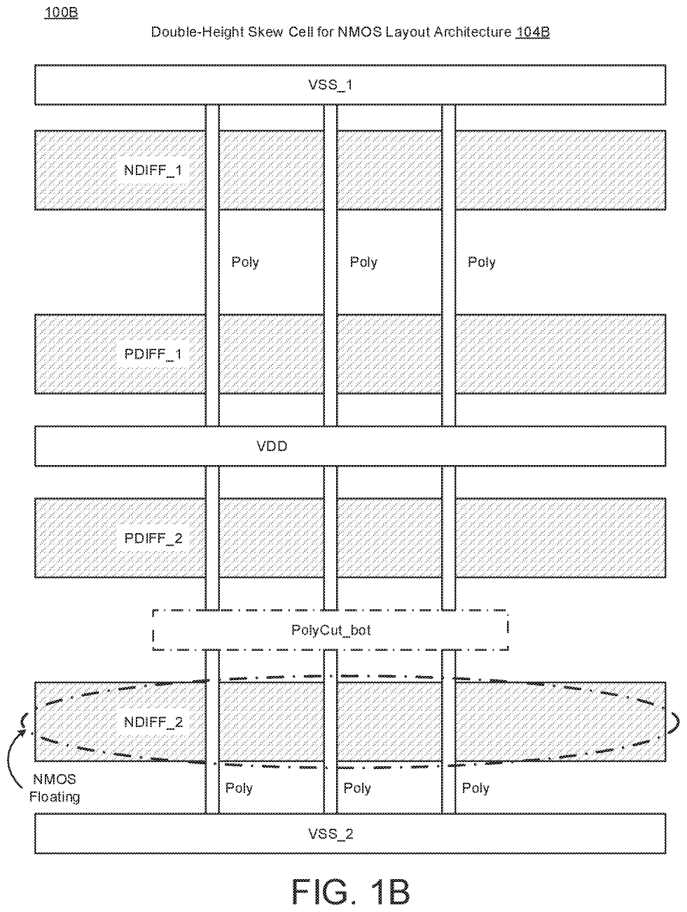

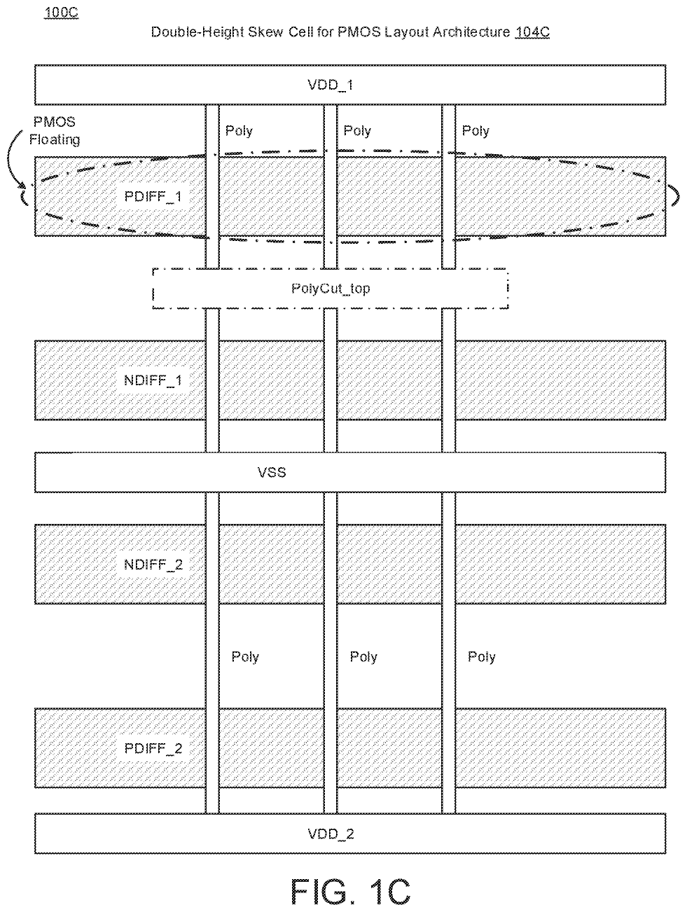

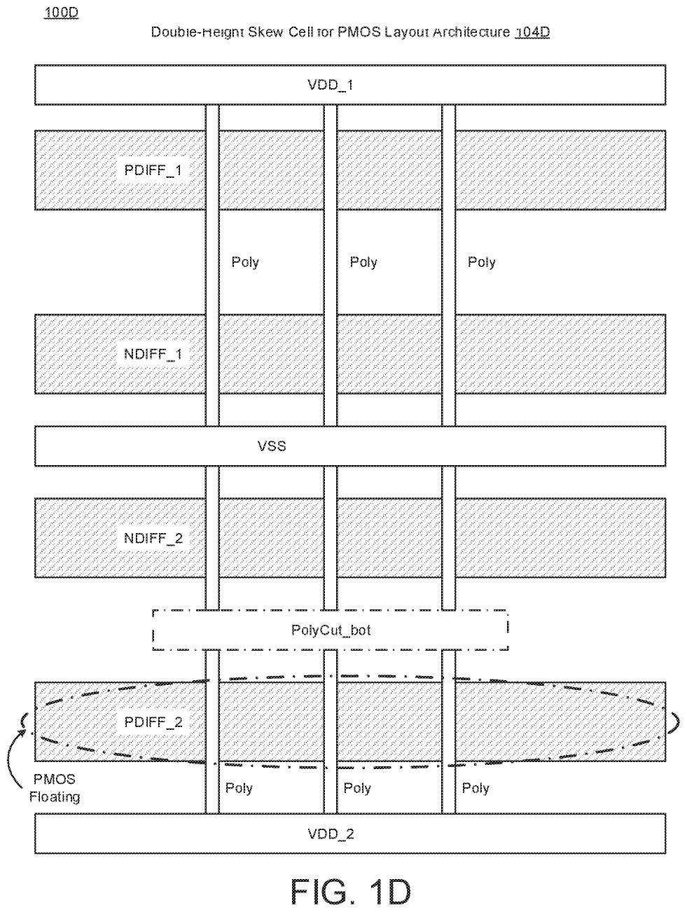

Various implementations of adiabatic stepwise clocking techniques for various circuit applications will be described in greater detail herein in FIGS. 1A-1D and 2-5.

FIGS. 1A-1D illustrate diagrams of double-height skew cell layout architecture in accordance with various implementations described herein. In particular, FIGS. 1A-1B show diagrams 100A, 100B of double-height skew cell for NMOS layout architectures 104A, 104B, and FIGS. 1C-1D show diagrams 100C, 100D of double-height skew cell for PMOS layout architectures 104C, 104D.

FIG. 1A shows a diagram 100A of a double-height skew cell for NMOS layout architecture 104A in accordance with various implementations described herein.

In some implementations, the double-height skew cell layout architecture 104A in FIG. 1A may refer to rise skew cell architecture that may be implemented as a system or a device with various integrated circuit (IC) components that are arranged and coupled together as an assemblage or some combination of parts that provide for physical circuit designs and related structures. In some instances, a method of designing, providing and fabricating double-height skew cell layout architecture 104A as an integrated system or device may involve use of various IC circuit components and structures described herein so as to implement fabrication schemes and techniques associated therewith. Also, in some instances, the double-height skew cell layout architecture 104A may be integrated with various computing circuitry and related components on a single chip, and in addition, the double-height skew cell layout architecture 104A may be implemented in embedded devices or systems for automotive, mobile, computer, server and Internet-of-things (IoT) applications, including remote sensor nodes.

As shown in FIG. 1A, double-height skew cell for NMOS layout architecture 104A may refer to rise skew cell architecture for various circuit related applications. Also, in some applications, the skew cell architecture 104A may have diffusion regions including P-type diffusion regions (PDIFF) disposed between N-type diffusion regions (NDIFF). The skew cell architecture 104A may include power rails including at least one voltage supply rail (VDD) disposed between one or more ground rails (VSS or GND). Also, the skew cell architecture 104A may include one or more poly-gate rails (Poly) disposed between the ground rails (VSS or GND). Moreover, the poly-gate rails (Poly) may be cut to provide an open space (PolyCut) between at least one N-type diffusion region (NDIFF) and at least one P-type diffusion region (PDIFF), and the open space (PolyCut) may be disposed at a first side or top-side (PolyCut_top) of the skew cell layout architecture 104A. Also, cutting one or more of the poly rails (Poly) at the first side or top-side (PolyCut_top) of the skew cell layout architecture 104A may provide for a floating NMOS device. In some instances, NDIFF_1 (i.e., NMOS floating transistors) is tied-off to ground (VSS or GND).

In some implementations, the at least one N-type diffusion region (NDIFF) may be cut-off and/or separated (and/or tied-off to ground) by the open space (by way of the PolyCut_top) from the other N-type diffusion regions (NDIFF) and the P-type diffusion regions (PDIFF) so as to provide a rise skew cell structure. Also, the N-type diffusion regions (NDIFF) include a first N-type diffusion region (NDIFF_1) and a second N-type diffusion region (NDIFF_2), and also, the P-type diffusion regions (PDIFF) may include a first P-type diffusion region (PDIFF_1) and a second P-type diffusion region (PDIFF_2). The first N-type diffusion region (NDIFF_1) and the first P-type diffusion region (PDIFF_1) may be disposed between voltage supply rail (VDD) and first ground rail (VSS_1) of the ground rails (VSS or GND), and the second N-type diffusion region (NDIFF_2) and the second P-type diffusion region (PDIFF_2) may be disposed between the voltage supply rail (VDD) and a second ground rail (VSS_2) of the ground rails (VSS or GND). Also, the poly-gate rails (Poly) may be cut between the first N-type diffusion region (NDIFF_1) and the first P-type diffusion region (PDIFF_1) so as to provide the open space (by way of PolyCut_top) between the first N-type diffusion region (NDIFF_1) and the first P-type diffusion region (PDIFF_1).

FIG. 1B shows a diagram 100B of a double-height skew cell for NMOS layout architecture 104B in accordance with various implementations described herein. Similar elements and features in FIG. 1B are similar in scope to those in FIG. 1A.

In some implementations, as shown in FIG. 1B, the poly-gate rails (Poly) may be cut to provide another open space (PolyCut_bot) between the second N-type diffusion region (NDIFF_2) and the second P-type diffusion region (PDIFF_2), and the open space (PolyCut) may be disposed at a second side or bottom-side (PolyCut_bot) of the skew cell layout architecture 104\B. Also, cutting one or more of the poly rails (Poly) at the second side or bottom-side (PolyCut_bot) of the skew cell layout architecture 104B may provide for another floating NMOS device in a different location. As such, as shown in FIG. 1B, the poly-gate rails (Poly) may be cut between second N-type diffusion region (NDIFF_2) and second P-type diffusion region (PDIFF_2) so as to provide the open space (by way of PolyCut_bot) between the second N-type diffusion region (NDIFF_2) and the second P-type diffusion region (PDIFF_2). In some instances, NDIFF_2 (i.e., NMOS floating transistors) is tied-off to ground (VSS or GND).

In reference to FIGS. 1A-1B, the skew cell architectures 104A, 104B may refer to a double-height rise skew cell having the voltage supply rail (VDD) as a shared voltage supply rail disposed between a first pair of NP diffusion regions (NDIFF_1, PDIFF_1) and a second pair of NP diffusion regions (NDIFF_2, PDIFF_2). The first pair of NP diffusion regions (NDIFF_1, PDIFF_1) may include the first N-type diffusion region (NDIFF_1) and the first P-type diffusion region (PDIFF_1) that are disposed between the shared voltage supply rail (VDD) and the first ground rail (VSS_1). Also, the second pair of NP diffusion regions (NDIFF_2, PDIFF_2) may include the second N-type diffusion region (NDIFF_2) and the second P-type diffusion region (PDIFF_2) disposed between the shared voltage supply rail (VDD) and the second ground rail (VSS_2).

FIG. 1C shows a diagram 100C of a double-height skew cell for PMOS layout architecture 104C in accordance with various implementations described herein.

In some implementations, the double-height skew cell layout architecture 104C in FIG. 1C may refer to fall skew cell architecture that may be implemented as a system or a device with various integrated circuit (IC) components that are arranged and coupled together as an assemblage or some combination of parts that provide for physical circuit designs and related structures. In some instances, a method of designing, providing and fabricating double-height skew cell layout architecture 104C as an integrated system or device may involve use of various IC circuit components and structures described herein so as to implement fabrication schemes and techniques associated therewith. Also, in some instances, the double-height skew cell layout architecture 104C may be integrated with various computing circuitry and related components on a single chip, and in addition, the double-height skew cell layout architecture 104C may be implemented in embedded devices or systems for automotive, mobile, computer, server and Internet-of-things (IoT) applications, including remote sensor nodes.

As shown in FIG. 1C, double-height skew cell for PMOS layout architecture 104C may refer to fall skew cell architecture for various circuit related applications. Also, in some applications, the skew cell architecture 104C may have diffusion regions including N-type diffusion regions (NDIFF) disposed between P-type diffusion regions (PDIFF). The skew cell architecture 104C may have power rails including at least one ground rail (VSS or GND) disposed between one or more voltage supply rails (VDD). Also, the skew cell architecture 104C may include one or more poly-gate rails (Poly) disposed between the voltage supply rails (VDD). Moreover, the poly-gate rails (Poly) may be cut to provide an open space (PolyCut) between at least one P-type diffusion region (PDIFF) and at least one N-type diffusion region (NDIFF), and the open space (PolyCut) may be disposed at a first side or top-side (PolyCut_top) of the skew cell layout architecture 104C. Also, cutting one or more of the poly rails (Poly) at the first side or top-side (PolyCut_top) of the skew cell layout architecture 104C may provide for a floating PMOS device. In some instances, PDIFF_1 (i.e., PMOS floating transistors) is tied-off to ground (VSS or GND).

In some implementations, the at least one P-type diffusion region (PDIFF) may be cut-off and/or separated (and/or tied-off to ground) by the open space (by way of the PolyCut_top) from the other P-type diffusion regions (PDIFF) and the N-type diffusion regions (NDIFF) so as to provide a fall skew cell structure. Also, the P-type diffusion regions (PDIFF) include a first P-type diffusion region (PDIFF_1) and a second P-type diffusion region (PDIFF_2), and also, the N-type diffusion regions (NDIFF) may include a first N-type diffusion region (NDIFF_1) and a second N-type diffusion region (NDIFF_2). Also, the first P-type diffusion region (PDIFF_1) and the first N-type diffusion region (NDIFF_1) may be disposed between the ground rail (VSS or GND) and first voltage supply rail (VDD_1) of the voltage supply rails (VDD), and the second P-type diffusion region (PDIFF_2) and the second N-type diffusion region (NDIFF_2) may be disposed between the ground rail (VSS or GND) and a second voltage supply rail (VDD_2) of the voltage supply rails (VDD). The poly-gate rails (Poly) may be cut between first P-type diffusion region (PDIFF_1) and first N-type diffusion region (NDIFF_1) so as to provide open space (by way of PolyCut_top) between the first P-type diffusion region (PDIFF_1) and the first N-type diffusion region (NDIFF_1).

FIG. 1D shows a diagram 100D of a double-height skew cell for PMOS layout architecture 104D in accordance with various implementations described herein. Similar elements and features in FIG. 1D are similar in scope to those in FIG. 1C.

In some implementations, as shown in FIG. 1D, the poly-gate rails (Poly) may be cut to provide another open space (PolyCut_bot) between the second P-type diffusion region (PDIFF_2) and the second N-type diffusion region (NDIFF_2), and the open space (PolyCut) may be disposed at a second side or bottom-side (PolyCut_bot) of the skew cell layout architecture 104B. Also, cutting one or more of the poly rails (Poly) at the second side or bottom-side (PolyCut_bot) of the skew cell layout architecture 104D may provide for another floating PMOS device in a different location. As such, as shown in FIG. 1D, the poly-gate rails (Poly) may be cut between second P-type diffusion region (PDIFF_2) and second N-type diffusion region (NDIFF_2) so as to provide the open space (by way of PolyCut_bot) between the second P-type diffusion region (PDIFF_2) and the second N-type diffusion region (NDIFF_2). In some instances, PDIFF_2 (i.e., PMOS floating transistors) is tied-off to ground (VSS or GND).

In reference to FIGS. 1C-1D, the skew cell architectures 104C, 104D may refer to a double-height fall skew cell having the ground rail (VSS or GND) as a shared ground rail disposed between a first pair of PN diffusion regions (PDIFF_1, NDIFF_1) and a second pair of PN diffusion regions (PDIFF_2, NDIFF_2). The first pair of PN diffusion regions (PDIFF_1, NDIFF_1) may include the first P-type diffusion region (PDIFF_1) and the first N-type diffusion region (NDIFF_1) that are disposed between the shared ground rail (VSS or GND) and the first voltage supply rail (VDD_1). Also, the second pair of PN diffusion regions (PDIFF_2, NDIFF_2) may include the second P-type diffusion region (PDIFF_2) and the second N-type diffusion region (NDIFF_2) disposed between shared ground rail (VSS or GND) and the second voltage supply rail (VDD_2).

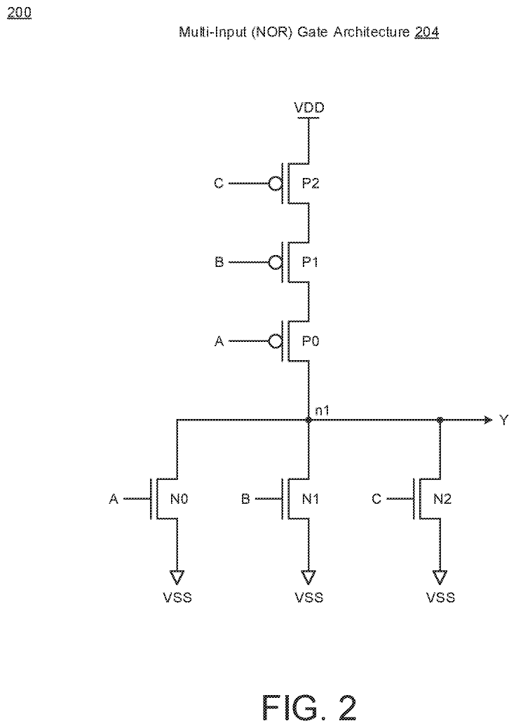

FIG. 2 illustrates a schematic diagram 200 of multi-input gate architecture 204 in accordance with various implementations described herein.

In some implementations, the gate architecture 204 in FIG. 2 may refer to a multi-input NOR gate architecture that may be implemented as a system or a device with various integrated circuit (IC) components that are arranged and coupled together as an assemblage or some combination of parts that provide for physical circuit designs and related structures. In some instances, a method of designing, providing and/or fabricating the gate architecture 204 as an integrated system or device may involve use of various IC circuit components and/or structures described herein so as to implement fabrication schemes and/or techniques associated therewith. Also, in various applications, the gate architecture 204 may be integrated with computing circuitry and related components on a single chip, and in addition, the gate architecture 204 may be implemented in embedded devices or systems for automotive, mobile, computer, server and Internet-of-things (IoT) applications, including remote sensor nodes.

As shown in FIG. 2, the multi-input gate architecture 204 may include multiple transistors such as, e.g., N-type transistors (N0, N1, N2) and P-type transistors (P0, P1, P2) that are coupled together to operate as a 3-input NOR gate. In various applications, the P-type transistors (P0, P1, P2) may be coupled in series between the voltage supply (VDD) and output node (n1), and also, the N-type transistors (N0, N1, N2) may be coupled in parallel between the output node (n1) and ground (VSS or GND).

In some implementations, first input (A) may be coupled to a gate of first P-type transistor (P0), second input (B) may be coupled to a gate of second P-type transistor (P1), and third input (C) may be coupled to a gate of third P-type transistor (P2). The first input (A) may be coupled to a gate of a first N-type transistor (N0), the second input (B) may be coupled to a gate of a second N-type transistor (N1), and the third input (C) may be coupled to a gate of a third N-type transistor (N2). Also, in some scenarios, the output (Y) of the NOR gate may be coupled to the output node (n1).

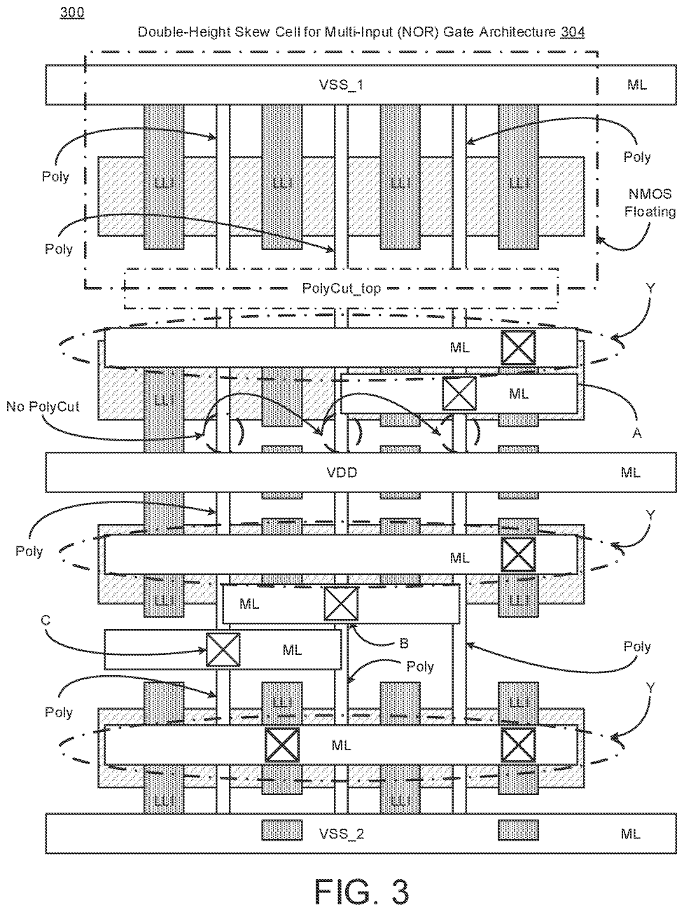

FIG. 3 illustrates a schematic diagram 300 of double-height skew gate layout architecture 304 in accordance with various implementations described herein. The NOR gate architecture 204 as shown in FIG. 2 may be used in conjunction with the NOR gate NMOS layout architecture 304 shown in FIG. 3, wherein similar elements and features are similar in scope, function and behavior.

In some implementations, the double-height skew cell layout architecture 304 in FIG. 3 may refer to rise skew cell architecture that may be implemented as a system or a device with various integrated circuit (IC) components that are arranged and coupled together as an assemblage or some combination of parts that provide for physical circuit designs and related structures. In some instances, a method of designing, providing and fabricating the double-height skew cell layout architecture 304 as an integrated system or device may involve use of various IC circuit components and structures described herein so as to implement fabrication schemes and techniques associated therewith. Also, in some instances, the double-height skew cell layout architecture 304 may be integrated with various computing circuitry and related components on a single chip, and in addition, the double-height skew cell layout architecture 304 may be implemented in embedded devices or systems for automotive, mobile, computer, server and Internet-of-things (IoT) applications, including remote sensor nodes.

As shown in FIG. 3, the double-height skew cell layout architecture 304 may refer to rise skew cell architecture for various circuit related applications, including, e.g., a double-height skew cell for a multi-input NOR gate layout architecture. Also, in various applications, the skew cell architecture 304 may include similar elements and features as the skew cell architecture 104A in FIG. 1A. Also, the NOR gate architecture 304 shown in FIG. 3 may be implemented in various other types of circuits including, e.g., an AND gate, an OR gate, an inverter, or similar circuit. For instance, in various applications, the skew cell architecture 304 may be implemented as a rise skewed inverter with 3 fingers, a fall skewed 2 input NAND gate with 3 fingers, and fall skewed 2 input AND-OR-INV cell with 1 finger. Therefore, the NOR gate architecture 304 shown in FIG. 3 is an example of a rise skew cell layout, and as such, any other similar logic circuit may be implemented with various design and/or layout schemes and/or techniques described herein.

In some implementations, the NOR gate architecture 304 may include multiple inputs and at least one output, such as, e.g., 3 inputs (A, B, C) and 1 output (Y). Also, the NOR gate architecture 304 may include multiple ground rails (VSS_1, VSS_2) and at least one voltage supply rail (VDD) along with multiple poly rails (Poly) and local interconnect rails (LLI), i.e., local layout interconnects (LLI). As shown in FIG. 3, the poly-gate rails (Poly) may be cut to provide an open space (PolyCut) between at least one N-type diffusion region (NDIFF) and at least one P-type diffusion region (PDIFF), and the open space (PolyCut) may be disposed at the first side or top-side (PolyCut_top) of the NOR gate layout architecture 304. Also, cutting one or more of the poly rails (Poly) at the first side or top-side (PolyCut_top) of the skew NOR gate layout architecture 304 may provide for a floating NMOS device. In some instances, NDIFF_1 (i.e., NMOS floating transistors) is tied-off to ground (VSS or GND). Therefore, in some applications, the NOR gate layout architecture 304 may be implemented as a rise skewed NMOS-NOR gate architecture for various circuit related implementations.

Also, in some implementations, the X-shaped boxes may include vias that are used to coupled the inputs (A, B, C) and the output (Y) to various elements and/or features in the NOR gate layout architecture 304 in a manner as shown in FIG. 3. As described herein, the NOR gate layout architecture 304 may be implemented, e.g., as a rise-skewed 3-input NOR gate, wherein a double-height skew cell is used with one entire row of NMOS devices (NMOS floating) being cut with PolyCut_top so as to provide a rise skew. Also, as shown in FIG. 3, there may be No PolyCut between the rows, and there may only be one metal layer (e.g., ML) to provide the gate connection in both rows, wherein a first row may be defined between VSS_1, and a second row may be defined between VSS_2 and VDD. Also, the input/output (IO) pins may have reduced length, which may contribute to reduction of gate capacitance with improved pin access and lesser route resource usage. Also, multiple output (Y) pins are possible so as to reduce the LLI resistance at the output of the NOR gate layout architecture 304.

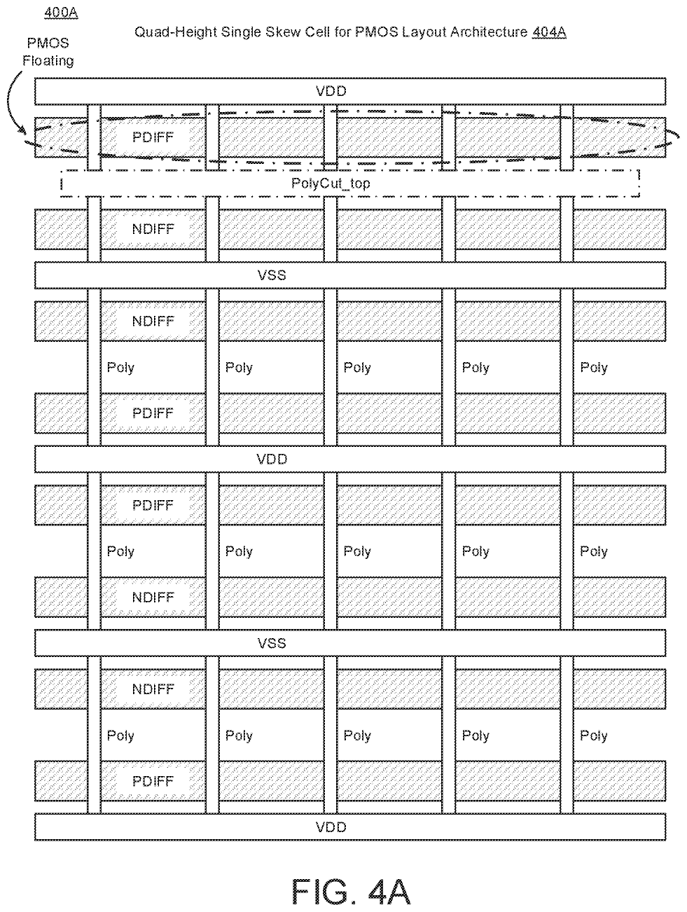

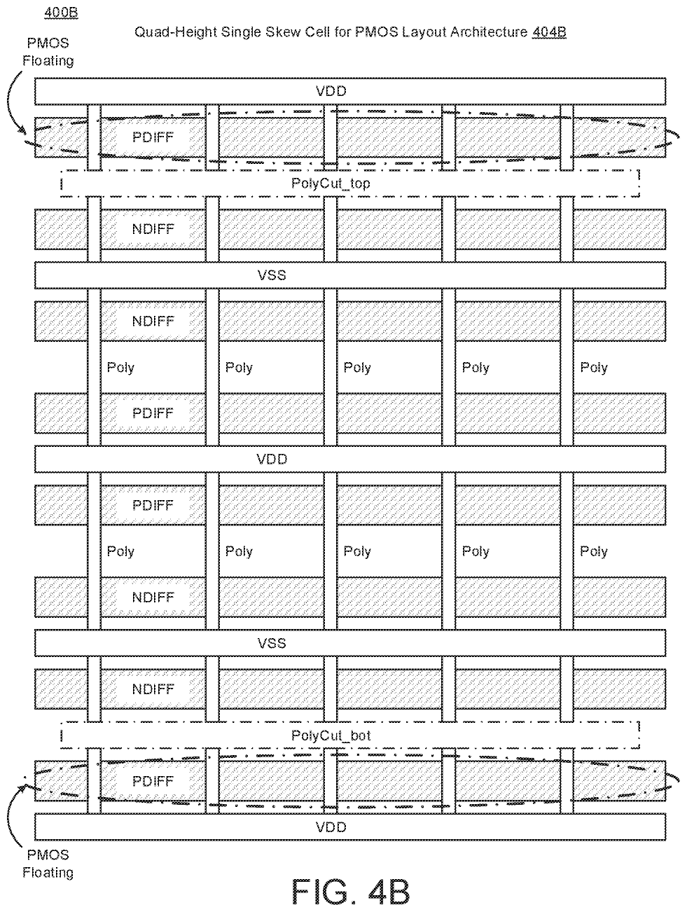

FIGS. 4A-4B illustrate diagrams of quad-height skew cell layout architecture in accordance with various implementations described herein. In particular, FIG. 4A shows a diagram 400A of quad-height skew cell layout architecture 404A, and FIG. 4B shows a diagram 400B of quad-height skew cell layout architecture 404B.

Various skew cell schemes and techniques described herein may be extended to any multi-height cell (e.g., quad-height), not just double-height. For larger cell heights, different degrees of rise and/or fall skews may be implemented. For smaller skew, floating NMOS/PMOS devices in a top row (top) or a bottom row (bot) may be implemented. Also, for larger skew, floating NMOS/PMOS devices may be implemented in both the top row and the bottom row. For instance, as shown in FIG. 4A, the quad-height skew cell layout architecture 404A may be fall skewed due to the PMOS floating devices created with open space from implementation of the PolyCut_top. Also, as shown in FIG. 4B, the quad-height skew cell layout architecture 404B may have and exhibit a greater fall skew due to multiple rows of PMOS floating devices (e.g., top and bottom) that are created with open space from implementation of the PolyCut_top and PolyCut_bot. In various instances, PDIFF (i.e., PMOS floating) is tied-off to ground (VSS or GND). In some other instances, NDIFF (i.e., NMOS floating) may be tied-off to ground (VSS or GND).

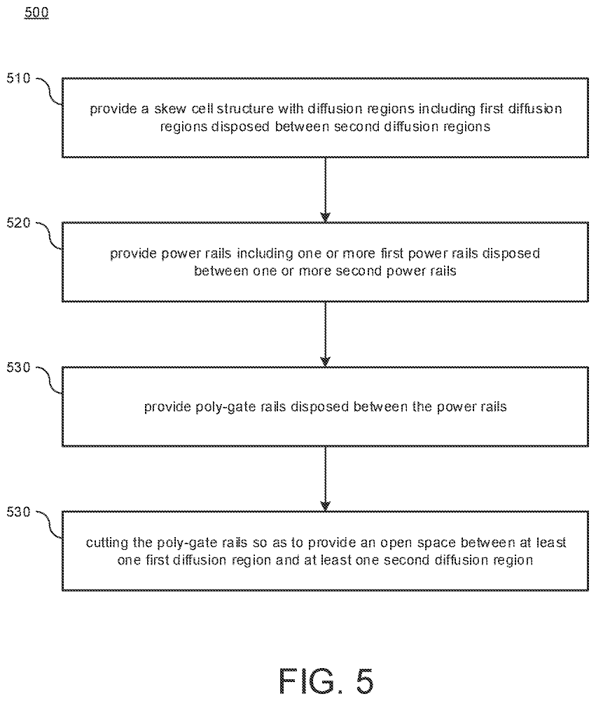

FIG. 5 illustrates a process diagram of a method 500 for providing skew cell layout architecture in accordance with various implementations described herein.

It should be understood that even though the method 500 indicates a particular order of operation execution, in some instances, various certain portions of the operations may be executed in a different order, and on different systems. In other cases, additional operations and/or steps may be added to and/or omitted from method 500. Also, method 500 may be implemented in hardware and/or software. If implemented in hardware, the method 500 may be implemented with various components and/or circuitry, as described herein in reference to FIGS. 1A-1D, 2-3, 4A-4B. If implemented in software, the method 500 may be implemented with program and/or software instruction processes configured for providing various skew cell layout architectures, as described herein. If implemented in software, instructions related to implementing the method 500 may be stored in memory and/or a database. In various instances, a computer or various other types of computing devices having a processor and memory may be configured to perform method 500.

In various implementations, method 500 may refer to a method for designing, providing, fabricating and/or manufacturing skew cell layout architectures as an integrated system, device and/or circuit that involves use of various IC circuit components described herein so as to thereby implement adiabatic stepwise clocking schemes and techniques associated therewith. The various skew cell layout architectures may be integrated with computing circuitry and/or related components on a single chip, and the various skew cell layout architectures may be implemented in embedded systems for various electronic, mobile and Internet-of-things (IoT) applications, including sensor nodes.

At block 510, the method 500 may provide a skew cell structure with diffusion regions including first diffusion regions disposed between second diffusion regions. Also, at block 520, method 500 may provide power rails including one or more first power rails disposed between one or more second power rails. Also, at block 530, method 500 may provide poly-gate rails disposed between the power rails. Also, at block 540, method 500 may be configured to cut one or more of the poly-gate rails so as to provide an open space between at least one first diffusion region and at least one second diffusion region.

In some implementations, the first diffusion regions may include P-type diffusion regions, the second regions may include N-type diffusion regions, and the one or more first power rails may include a voltage supply rail (VDD). The one or more second power rails may include ground rails (VSS or GND), the poly-gate rails may be disposed between the ground rails, and also, the poly-gate rails may be cut so as to provide an open space between at least one N-type diffusion region and at least one P-type diffusion region. The at least one N-type diffusion region may be cut-off and/or separated (and/or tied-off to ground) by the open space from the other N-type diffusion regions and the P-type diffusion regions so as to thereby provide a rise skew cell structure.

Also, in some implementations, the first diffusion regions may include N-type diffusion regions, the second regions may include P-type diffusion regions, and the one or more first power rails include a ground rail (VSS or GND). Also, the one or more second power rails may include voltage supply rails (VDD), the poly-gate rails may be disposed between the voltage supply rails (VDD), and the poly-gate rails may be cut so as to provide an open space between at least one P-type diffusion region and at least one N-type diffusion region. Also, the at least one P-type diffusion region may be cut-off or separated (and/or tied-off to ground) by the open space from the other P-type diffusion regions and the N-type diffusion regions so as to provide a fall skew cell structure.

Also, in some implementations, the skew cell structure may comprise a double-height skew cell having a first pair of PN diffusion regions and a second pair of PN diffusion regions, and the first pair of PN diffusion regions may include a first N-type diffusion region and a first P-type diffusion region. Further, the second pair of PN diffusion regions may include a second N-type diffusion region and a second P-type diffusion region.

In reference to the various skew cell schemes and techniques described herein, skew cell NMOS/PMOS layout architectures provide is a novel way of providing physical layout designs for the rise/fall skewed single staged CMOS logic cells. Also, the various skew cell schemes and techniques described herein may provide for improved timing and leakage due to improved route-ability and parasitic leakage. Also, gate coupled poly may assist with reducing overall metal layer (e.g., ML) resource requirements. Also, the local interconnect (LLI) may be directly coupled or connected without the need of ML jumpers for some functionalities. Also, overall metal layer (ML) route length may be reduced due to implementing multi-height skew cell structures. Moreover, there are more open tracks available for coupling the output connection, so as to reduce the need of local interconnect (LLI) for output and subsequently the output resistance.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this disclosure.

Described herein are various implementations of a device having a skew cell architecture with diffusion regions including P-type diffusion regions disposed between N-type diffusion regions. The device may have power rails including a voltage supply rail disposed between ground rails. The device may have poly-gate rails disposed between the ground rails. The poly-gate rails may be cut to provide an open space between at least one N-type diffusion region and at least one P-type diffusion region.

Described herein are various implementations of a device having a skew cell architecture with diffusion regions including N-type diffusion regions disposed between P-type diffusion regions. The device may have power rails including a ground rail disposed between voltage supply rails. The device may have poly-gate rails disposed between the voltage supply rails. The poly-gate rails may be cut to provide an open space between at least one P-type diffusion region and at least one N-type diffusion region.

Described herein are various implementations of a method. The method may provide a skew cell structure with diffusion regions including first diffusion regions disposed between second diffusion regions. The method may provide power rails including one or more first power rails disposed between one or more second power rails. The method may provide poly-gate rails disposed between the power rails. The method may cut the poly-gate rails so as to provide an open space between at least one first diffusion region and at least one second diffusion region.

Reference has been made in detail to various implementations, examples of which are illustrated in the accompanying drawings and figures. In the following detailed description, numerous specific details are set forth to provide a thorough understanding of the disclosure provided herein. However, the disclosure provided herein may be practiced without these specific details. In some other instances, well-known methods, procedures, components, circuits and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the disclosure provided herein is for the purpose of describing particular implementations and is not intended to limit the disclosure provided herein. As used in the description of the disclosure provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. The terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various related techniques described herein, other and further implementations may be devised in accordance with the disclosure herein, which may be determined by the claims that follow.

Although the subject matter has been described herein in language specific to structural features and/or methodological acts, it should be understood that the subject matter defined in the appended claims is not necessarily limited to the specific features or acts described above. Rather, specific features and acts described above are disclosed as example forms of implementing the claims.

What is claimed is:

1. A device comprising:
a skew cell architecture having diffusion regions including P-type diffusion regions disposed between N-type diffusion regions;
power rails including a voltage supply rail disposed between ground rails; and
poly-gate rails disposed between the ground rails,
wherein the poly-gate rails are cut to provide an open space between at least one N-type diffusion region and at least one P-type diffusion region.

2. The device of claim 1, wherein:
the at least one N-type diffusion region is cut-off or separated by the open space from the other N-type diffusion regions and the P-type diffusion regions so as to provide a rise skew cell structure.

3. The device of claim 1, wherein:
the N-type diffusion regions include a first N-type diffusion region and a second N-type diffusion region, and
the P-type diffusion regions include a first P-type diffusion region and a second P-type diffusion region.

4. The device of claim 3, wherein:
the first N-type diffusion region and the first P-type diffusion region are disposed between the voltage supply rail and a first ground rail of the ground rails, and
the second N-type diffusion region and the second P-type diffusion region are disposed between the voltage supply rail and a second ground rail of the ground rails.

5. The device of claim 4, wherein:
wherein the poly-gate rails are cut between the first N-type diffusion region and the first P-type diffusion region so as to provide the open space between the first N-type diffusion region and the first P-type diffusion region.

6. The device of claim 4, wherein:
wherein the poly-gate rails are cut between the second N-type diffusion region and the second P-type diffusion region so as to provide the open space between the second N-type diffusion region and the second P-type diffusion region.

7. The device of claim 4, wherein:
the skew cell architecture comprises a double-height skew cell having the voltage supply rail as a shared voltage supply rail disposed between a first pair of NP diffusion regions and a second pair of NP diffusion regions,
the first pair of NP diffusion regions includes the first N-type diffusion region and the first P-type diffusion region that are disposed between the shared voltage supply rail and the first ground rail, and
the second pair of NP diffusion regions includes the second N-type diffusion region and the second P-type diffusion region disposed between the shared voltage supply rail and the second ground rail.

8. A device comprising:
a skew cell architecture having diffusion regions including N-type diffusion regions disposed between P-type diffusion regions;
power rails including a ground rail disposed between voltage supply rails; and
poly-gate rails disposed between the voltage supply rails,
wherein the poly-gate rails are cut to provide an open space between at least one P-type diffusion region and at least one N-type diffusion region.

9. The device of claim 8, wherein:
the at least one P-type diffusion region is cut-off or separated by the open space from the other P-type diffusion regions and the N-type diffusion regions so as to provide a fall skew cell structure.

10. The device of claim 8, wherein:
the P-type diffusion regions include a first P-type diffusion region and a second P-type diffusion region, and
the N-type diffusion regions include a first N-type diffusion region and a second N-type diffusion region.

11. The device of claim 10, wherein:
the first P-type diffusion region and the first N-type diffusion region are disposed between the ground rail and a first voltage supply rail of the voltage supply rails, and
the second P-type diffusion region and the second N-type diffusion region are disposed between the ground rail and a second voltage supply rail of the voltage supply rails.

12. The device of claim 11, wherein:
wherein the poly-gate rails are cut between the first P-type diffusion region and the first N-type diffusion region so as to provide the open space between the first P-type diffusion region and the first N-type diffusion region.

13. The device of claim 11, wherein:
wherein the poly-gate rails are cut between the second P-type diffusion region and the second N-type diffusion region so as to provide the open space between the second P-type diffusion region and the second N-type diffusion region.

14. The device of claim 11, wherein:
the skew cell architecture comprises a double-height skew cell having the ground rail as a shared ground rail disposed between a first pair of PN diffusion regions and a second pair of PN diffusion regions,
the first pair of PN diffusion regions includes the first P-type diffusion region and the first N-type diffusion region that are disposed between the shared ground rail and the first voltage supply rail, and
the second pair of PN diffusion regions includes the second P-type diffusion region and the second N-type diffusion region disposed between the shared ground rail and the second voltage supply rail.

15. A method comprising:
providing a skew cell structure with diffusion regions including first diffusion regions disposed between second diffusion regions;
providing power rails including one or more first power rails disposed between one or more second power rails; and
providing poly-gate rails disposed between the power rails,
cutting the poly-gate rails so as to provide an open space between at least one first diffusion region and at least one second diffusion region.

16. The method of claim 15, wherein:
the first diffusion regions include P-type diffusion regions,
the second regions include N-type diffusion regions,
the one or more first power rails include a voltage supply rail,
the one or more second power rails include ground rails,
the poly-gate rails disposed between the ground rails, and
the poly-gate rails are cut to provide an open space between at least one N-type diffusion region and at least one P-type diffusion region.

17. The method of claim 16, wherein:
the at least one N-type diffusion region is cut-off or separated by the open space from the other N-type diffusion regions and the P-type diffusion regions so as to provide a rise skew cell structure.

18. The method of claim 15, wherein:
the first diffusion regions include N-type diffusion regions,
the second regions include P-type diffusion regions,
the one or more first power rails include a ground rail,
the one or more second power rails include voltage supply rails,
the poly-gate rails disposed between the voltage supply rails, and
the poly-gate rails are cut to provide an open space between at least one P-type diffusion region and at least one N-type diffusion region.

19. The method of claim 18, wherein:
the at least one P-type diffusion region is cut-off or separated by the open space from the other P-type diffusion regions and the N-type diffusion regions so as to provide a fall skew cell structure.

20. The method of claim 15, wherein:
the skew cell structure comprises a double-height skew cell having a first pair of PN diffusion regions and a second pair of PN diffusion regions,
the first pair of PN diffusion regions includes a first N-type diffusion region and a first P-type diffusion region, and
the second pair of PN diffusion regions includes a second N-type diffusion region and a second P-type diffusion region.
